(19) United States
(12) Patent Application Publication
(10) Pub. No.: US 2026/0148534 A1
(43) Pub. Date: May 28, 2026

(54) MACHINE LEARNING DEVICE, SKILL DETERMINATION DEVICE, MACHINE LEARNING METHOD, AND STORAGE MEDIUM STORING MACHINE LEARNING PROGRAM

(71) Applicant: Mitsubishi Electric Corporation, TOKYO (JP)

(72) Inventors: Yuichi SASAKI, Tokyo (JP); Takafumi KOIKE, Tokyo (JP)

(73) Assignee: Mitsubishi Electric Corporation, TOKYO (JP)

(21) Appl. No.: 19/455,152

(22) Filed: Jan. 21, 2026

Related U.S. Application Data
(63) Continuation of application No. PCT/JP2023/031746, filed on Aug. 31, 2023.

(51) Int. Cl. G06V 10/774; G06V 10/25; G06V 10/62; G06V 10/74; G06V 20/40; G06V 40/20

(52) U.S. Cl. CPC G06V 10/7747; G06V 10/25; G06V 10/62; G06V 10/761; G06V 20/41; G06V 20/46; G06V 40/20

(57) ABSTRACT

A machine learning device includes processing circuitry to select a plurality of video pairs, to generate an attention region in image frames, to perform determination of the superiority or inferiority of the skill level in the attention region by using the learning model in regard to each video pair, and to store the learning model and to update the learning model based on a result of the determination of the superiority or inferiority of the skill level. The processing circuitry selects the image frames to be used for determining the superiority or inferiority of the skill level by using selection probability determined based on one or more of user editing in the image frames forming each video pair, a feature in a time direction in a plurality of sequential image frames forming each video pair, and a similarity level between the image frames forming each video pair.

### CROSS-REFERENCE TO RELATED APPLICATION

This application is a continuation application of International Application No. PCT/JP2023/031746 having an international filing date of Aug. 31, 2023, all of which is hereby expressly incorporated by reference into the present application.

### BACKGROUND OF THE INVENTION

### 1. Field of the Invention

The present disclosure relates to a machine learning device, a skill determination device, a machine learning method, and a machine learning program.

### 2. Description of the Related Art

Pairwise deep ranking (PDR) has been proposed. This technology is one of techniques for making skill assessments, which calculates a score regarding a skill level (i.e., proficiency level) of a person's action and determines the relative quality of the skill level (see Non-patent Reference 1, for example).
Non-patent Reference 1: Masayuki Takada and three others (Chubu University), “Attention Pairwise Ranking: Visual Explanations in Skill Assessment”, The 23rd Meeting on Image Recognition and Understanding.

However, in the above-described conventional technology, provided information includes only the superiority or inferiority of the skill and a video pair, and there are cases where the superiority or inferiority of the skill is determined based on places other than places that should be paid attention to in order to determine the superiority or inferiority (i.e., biased attention regions in the video pair). For example, in an assessment of the skill of the action of drawing a picture, there are cases where the superiority or inferiority of the skill is determined based on not a video in a period when a pen is moved but a video in a period when the head of the person moving the pen is captured. Therefore, the conventional technology has a problem in that learning behavior can become unstable.

### SUMMARY OF THE INVENTION

An object of the present disclosure is to stabilize the learning behavior in the learning of a learning model for inferring the skill level of the action of an action subject in a video.

A machine learning device in the present disclosure is a device that learns a learning model for inferring a skill level of an action of an action subject in a video. The machine learning device includes processing circuitry to select a plurality of video pairs from a video data set for learning and to select image frames to be used for determining superiority or inferiority of the skill level from each video pair forming the plurality of selected video pairs; to generate an attention region to be used for determining the superiority or inferiority of the skill level in the image frames; to perform determination of the superiority or inferiority of the skill level in the attention region by using the learning model in regard to each video pair; and to store the learning model and to update the learning model based on a result of the determination of the superiority or inferiority of the skill level. The processing circuitry selects the image frames to be used for determining the superiority or inferiority of the skill level by using selection probability determined based on one or more of user editing in the image frames forming each video pair, a feature in a time direction in a plurality of sequential image frames forming each video pair, and a similarity level between the image frames forming each video pair.

A machine learning method in the present disclosure is a method of learning a learning model for inferring a skill level of an action of an action subject in a video. The machine learning method includes selecting a plurality of video pairs from a video data set for learning and selecting image frames to be used for determining superiority or inferiority of the skill level from each video pair forming the plurality of selected video pairs; generating an attention region to be used for determining the superiority or inferiority of the skill level in the image frames; performing determination of the superiority or inferiority of the skill level in the attention region by using the learning model in regard to each video pair; and storing the learning model and updating the learning model based on a result of the determination of the superiority or inferiority of the skill level. In said selecting image frames to be used for determining the superiority or inferiority of the skill level, the image frames to be used for determining the superiority or inferiority of the skill level are selected by using selection probability determined based on one or more of user editing in the image frames forming each video pair, a feature in a time direction in a plurality of sequential image frames forming each video pair, and a similarity level between the image frames forming each video pair.

According to the present disclosure, the learning behavior in the learning of the learning model for inferring the skill level of the action of the action subject in a video can be stabilized.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is an explanatory diagram showing a conventional system (first comparative example) for performing superiority or inferiority determination of the skill;

FIG. 2 is a functional block diagram schematically showing the configuration of the system (first comparative example);

FIG. 3 is an explanatory diagram showing the operation of a conventional machine learning device (second comparative example) for determining the skill level of an action of a person captured in a video by using transfer learning;

FIG. 4 is a functional block diagram schematically showing the configuration of the machine learning device (second comparative example) in FIG. 3;

FIG. 5 is a functional block diagram schematically showing the configuration of a machine learning device according to a first embodiment;

FIG. 6 is a diagram showing an example of the hardware configuration of the machine learning device (or a skill determination device) according to the first embodiment;

FIG. 7A is a diagram showing segments of videos selected from a video pair by a data selection unit in the second comparative example, and FIG. 7B is a diagram showing parts selected from a video pair by a data preferential selection unit in the first embodiment;

FIG. 8 is an explanatory diagram showing effects achieved by the machine learning device according to the first embodiment;

FIG. 9 is an explanatory diagram showing the operation of the machine learning device according to the first embodiment;

FIG. 10 is a flowchart showing a learning operation performed by the machine learning device according to the first embodiment;

FIG. 11 is a flowchart showing annotation made by the machine learning device according to the first embodiment;

FIG. 12 is a functional block diagram schematically showing the configuration of a machine learning device according to a second embodiment;

FIG. 13 is a flowchart showing a learning operation performed by the machine learning device according to the second embodiment;

FIG. 14 is a functional block diagram schematically showing the configuration of a machine learning device according to a third embodiment;

FIG. 15 is a flowchart showing a learning operation performed by the machine learning device according to the third embodiment;

FIG. 16 is a functional block diagram schematically showing the configuration of a machine learning device according to a fourth embodiment;

FIG. 17 is a flowchart showing a learning operation performed by the machine learning device according to the fourth embodiment;

FIG. 18 is a functional block diagram schematically showing the configuration of a machine learning device according to a fifth embodiment; and

FIG. 19 is a flowchart showing a learning operation performed by the machine learning device according to the fifth embodiment.

### DETAILED DESCRIPTION OF THE INVENTION

A machine learning device, a skill determination device, a machine learning method and a machine learning program according to each embodiment will be described below with reference to the drawings. The following embodiments are just examples and it is possible to appropriately combine embodiments and appropriately modify each embodiment.

The machine learning device according to each embodiment is a device that learns a learning model to be used by an inference device (referred to also as a “skill determination device”) for inferring the skill level (i.e., proficiency level) of an action of an action subject captured in a video. The machine learning device according to each embodiment is, for example, a computer as an information processing device. The action subject captured in the video is a person performing work (referred to also as a “worker”). Further, the action subject captured in the video can include a mechanism (e.g., a device such as a robotic arm or an endoscope) that performs work by moving in conjunction with a person's movement.

The machine learning method according to each embodiment is a method that can be performed by the machine learning device. The machine learning method according to each embodiment is a method of learning a learning model for inferring the skill level of the action of the action subject in a video.

The machine learning program according to each embodiment is a software program that can be performed by a computer as the machine learning device. The machine learning program according to each embodiment is a program that learns a learning model for inferring the skill level of the action of the action subject captured in a video.

### (1) First Comparative Example

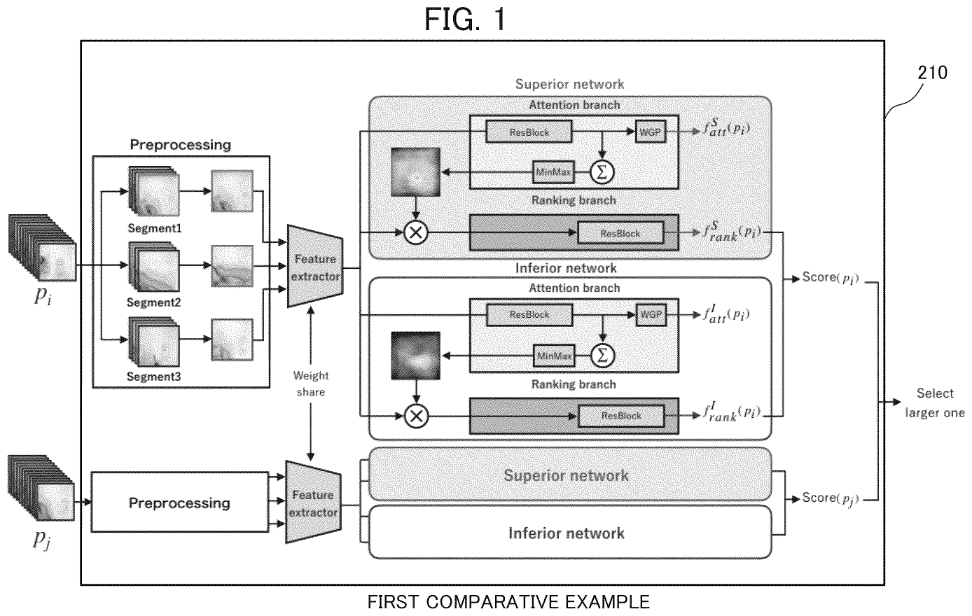

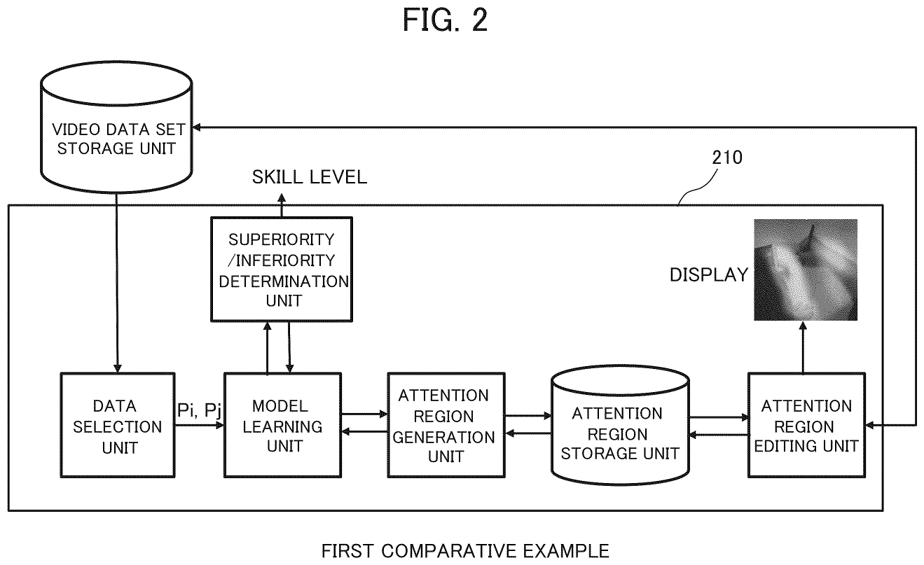

FIG. 1 is an explanatory diagram showing a conventional system (first comparative example) for performing the superiority or inferiority determination of the skill. In FIG. 1, a configuration proposed in the aforementioned Non-patent Reference 1 is shown as a system 210. FIG. 2 is a functional block diagram schematically showing the configuration of the system 210 (first comparative example). The input to the system as the first comparative example is a video pair (i.e., two videos Pᵢ and Pⱼ), where Pᵢ is a video of a superior skill compared to Pⱼ. This system is formed with a processing unit (Preprocessing) that divides a video into segments, a feature extractor that extracts a feature of a video, a superior network that assesses superior actions, and an inferior network that assesses inferior actions. Each of the superior network and the inferior network includes an attention branch and a ranking branch. An output value obtained when the video Pᵢ is inputted is Score(pᵢ) based on an output value from the superior network and an output value from the inferior network. An output value obtained when the video Pⱼ is inputted is Score(pⱼ) based on an output value from the superior network and an output value from the inferior network. The system 210 learns a magnitude relationship between the Scores of these two videos. When the video Pᵢ is superior to the video Pⱼ and the magnitude relationship between the Score(pᵢ) and the Score(pⱼ) is inverted, the difference between the Scores is given to a loss function for learning. As the loss function, it is possible to use Marginal Loss that causes only differences greater than or equal to a fixed value to be learned, SoftPlus that evaluates the loss due to a difference less than or equal to a fixed value as a small value, or the like, for example.

### (2) Second Comparative Example

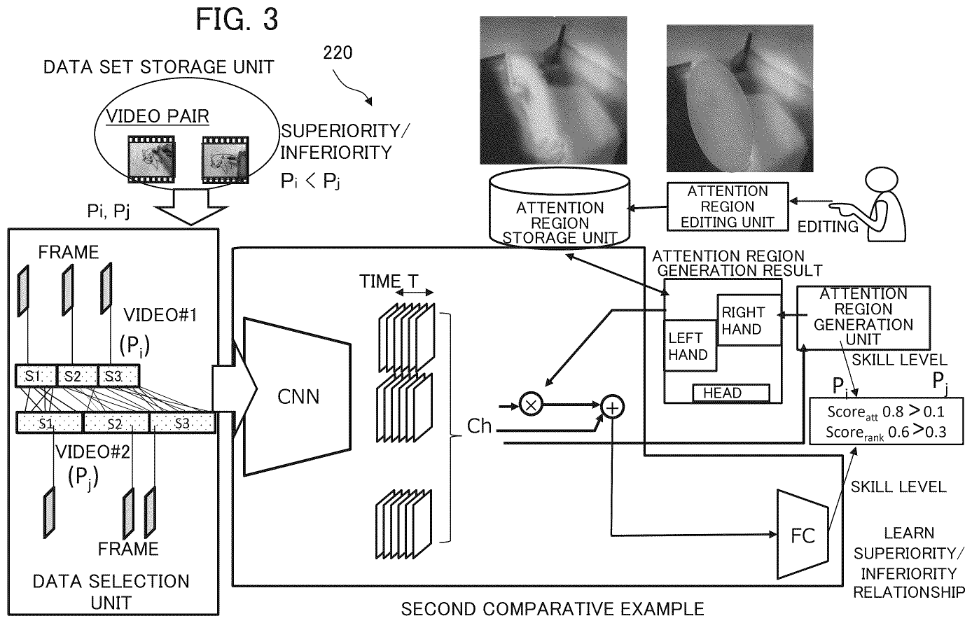

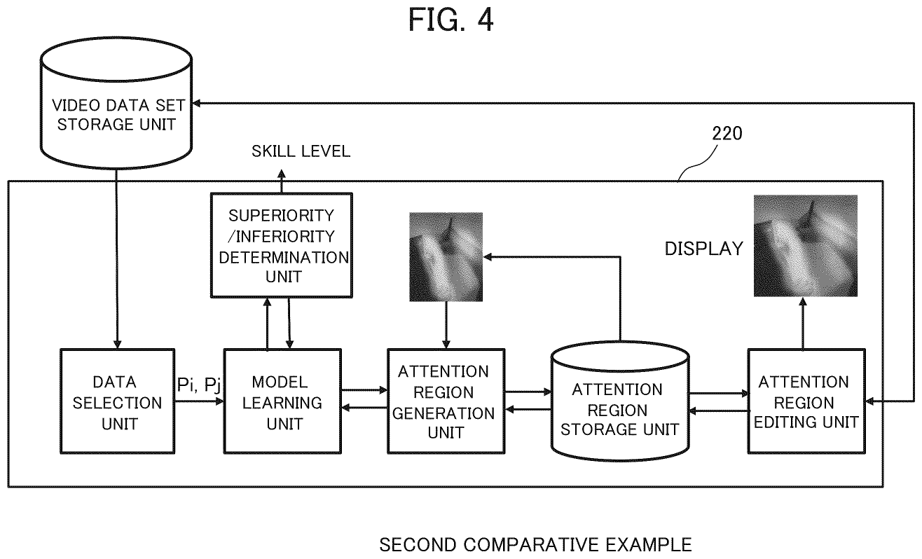

FIG. 3 is an explanatory diagram showing the operation of a conventional machine learning device (second comparative example) for determining the skill level of an action of a person captured in a video by using transfer learning. FIG. 3 shows the configuration of a machine learning device 220 proposed in Non-patent Reference 2. FIG. 4 is a functional block diagram showing functions of a learning model in FIG. 3.
Non-patent Reference 2: Masahiro Mitsuhara and six others, “Embedding Human Knowledge into Deep Neural Network via Attention Map”, arXiv: 1905.03540, May 9, 2019.

In the second comparative example, the transfer learning is performed, in which an attention region generated in regard to a video by an attention mechanism (a network that generates the attention region) is corrected by a human (i.e., human knowledge is embedded in the learning model) and the learning is performed by using the corrected attention region as correct answer data. Transfer learning is a human-in-the-loop (HITL) type of learning. By the transfer learning, a learning model that determines the skill level of an action of a person in a video while interacting with a user is generated, for example.

For example, in FIG. 3, a data selection unit selects a video pair (i.e., a video Pᵢ as a video #1 and a video Pⱼ as a video #2) from a data set storage unit. Here, the skill level of the video Pⱼ is superior to the skill level of the video Pᵢ (this relationship is represented also as “Pᵢ<P;”). In this case, the score Score(Pⱼ) of the skill captured in the video Pⱼ should be determined to be higher than the score Score(Pᵢ) of the skill captured in the video Pᵢ.

FIG. 3 shows an example in which the score Scoreₐₜₜ(Pⱼ)=0.1 of the skill captured in the video Pⱼ regarding the attention region that an attention region generation unit paid attention to is lower than the score Scoreₐₜₜ(pᵢ)=0.8 of the skill captured in the video Pᵢ (i.e., an example in which the relationship between the scores regarding the attention region is inverted from the originally natural score relationship) and an example in which the score Scoreᵣₐₙₖ(Pⱼ)=0.3 of the skill captured in the video Pⱼ regarding the output from an FC layer is lower than the score Scoreᵣₐₙₖ(Pᵢ)=0.6 of the skill captured in the video Pᵢ (i.e., an example in which the relationship between the scores outputted from the FC layer is inverted from the originally natural score relationship).

For learning to determine the superiority or inferiority of the proficiency level, the machine learning device first selects one frame of image from each of segments S1, S2 and S3 of the video #1 (i.e., the video Pᵢ) and the attention region generation unit calculates the Scoreₐₜₜ(Pᵢ) and the Scoreᵣₐₙₖ(Pᵢ), which are the scores regarding the video Pᵢ. FIG. 3 shows an example in which Scoreₐₜₜ(Pᵢ)=0.8 and Scoreᵣₐₙₖ(Pᵢ)=0.6.

Subsequently, the machine learning device selects one frame of image from each of segments S1, S2 and S3 of the video #2 (i.e., the video Pⱼ) and the attention region generation unit calculates the Scoreₐₜₜ(Pⱼ) and the Scoreᵣₐₙₖ(Pⱼ), which are the scores regarding the video Pⱼ. FIG. 3 shows an example in which Scoreₐₜₜ(Pⱼ)=0.1 and Scoreᵣₐₙₖ(Pⱼ)=0.3.

In this example, Scoreₐₜₜ(Pᵢ)=0.8>Scoreₐₜₜ(Pᵢ)=0.1 and Scoreᵣₐₙₖ(Pᵢ)=0.6>Scoreᵣₐₙₖ(Pᵢ)=0.3.

An example of a method of calculating the difference in the loss function from the scores and learning the superiority or inferiority determination of the skill captured in a video by using the difference is described in the aforementioned Non-patent Reference 1 (where the Score is represented by f).

### (3) First Embodiment

In the technology of the first comparative example shown in FIG. 1 and FIG. 2, for determining the superiority or inferiority of the skill levels of the actions of the people captured in the video pair (videos Pᵢ and Pⱼ), there are cases where the superiority or inferiority of the skill levels is determined based on places other than places that should be paid attention to (i.e., biased attention regions) and there are cases where the learning stability is low.

On the other hand, the attention region manually edited by a human (i.e., human knowledge is embedded therein) in the transfer learning in the second comparative example shown in FIG. 3 and FIG. 4 can be regarded as an important part in the video pair for determining the skill level of a person's action. For example, when the transfer learning is performed by a machine learning device that generates a learning model for assessing the skill of the action of drawing a picture, the possibility that the manual editing by a human is performed on a part in which no hand moving the pen has been captured can be considered to be low. Therefore, the part on which the editing is performed in the transfer learning can be considered to be a part in the video pair that is appropriate for determining the skill level of a person's action.

In the first embodiment, in the machine learning device that generates a learning model for determining the skill level of work captured in a video pair, video data of a part that has undergone the editing by the transfer learning (i.e., a part of the video to which the user is paying attention) is preferentially selected as attention data from the video pair and the learning is performed based on the selected attention data, by which the determination accuracy of the superiority or inferiority of the skill is increased and the learning stability is increased further.

The attention data means, for example, image frames on which a human performed editing (e.g., correction, addition, deletion or the like) of video data in the transfer learning, image data in a time range of a predetermined length including image frames edited in the transfer learning (i.e., image data from the X1-th image frame to the X2-th image frame where X1 and X2 are predetermined positive integers), data in which similarity of an intermediate feature included in the video is higher than or equal to a predetermined value, or the like. For example, a data preferential selection unit which will be described later performs a process of increasing selection probability of video data parts edited by the user (e.g., a process of setting a weight W to be greater than 1) by evaluating the weight W of the video data parts (image frames) edited by the user, setting the weight of video data parts (image frames) not undergone the video editing at 1, and making a roulette selection.

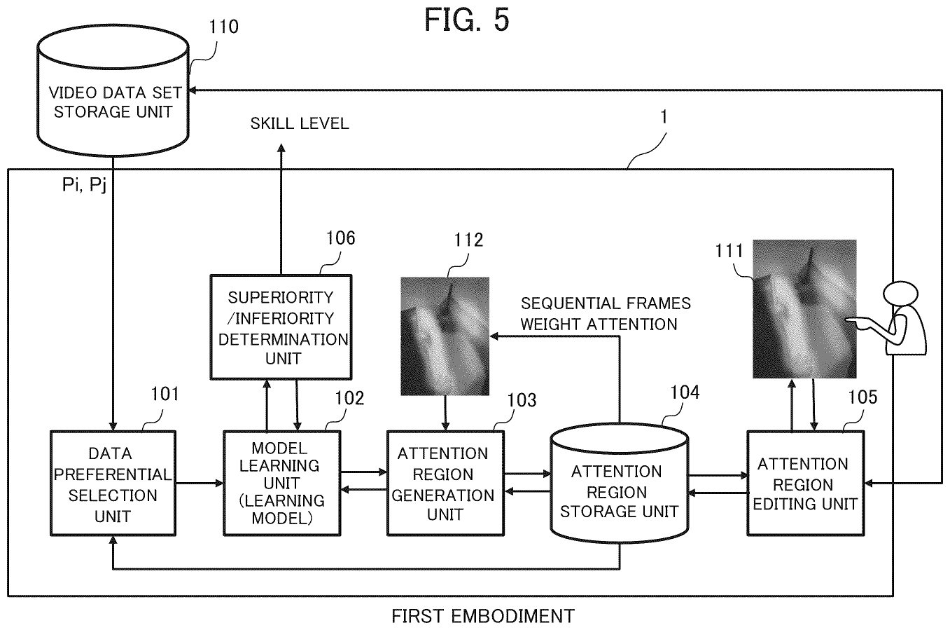

FIG. 5 is a functional block diagram schematically showing the configuration of a machine learning device 1 according to the first embodiment. The machine learning device 1 is a device that learns a learning model for inferring the skill level of an action of the action subject in a video. The machine learning device 1 includes a data preferential selection unit 101 that selects a plurality of video pairs (i.e., a plurality of pieces of video data) from a video data set for learning stored in a video data set storage unit 110 and selects image frames to be used for determining the superiority or inferiority of the skill level from each video pair forming the plurality of selected video pairs, an attention region generation unit 103 that generates an attention region to be used for determining the superiority or inferiority of the skill level in each image frame, a superiority/inferiority determination unit 106 that performs determination of the superiority or inferiority of the skill level in the attention region by using the learning model in regard to each video pair, and a model learning unit 102 that stores the learning model and updates the learning model based on the result of the determination of the superiority or inferiority of the skill level.

The machine learning device 1 includes an attention region editing unit 105 that performs editing of videos according to operations performed by the user viewing a display screen 111, an attention region storage unit 104 that stores the edited videos, and the attention region generation unit 103 that generates the attention region.

The data preferential selection unit 101 selects the image frames to be used for determining the superiority or inferiority of the skill level by using selection probabilities determined based on user editing in image frames forming each video pair. The data preferential selection unit 101 acquires information indicating what image frames in the videos have been edited by the user from the attention region storage unit 104. For example, the data preferential selection unit 101 sets the weight of already edited image frames at W (a value greater than 1), sets the weight of unedited image frames at 1, and calculates the selection probability, as the probability that an image frame is selected, for each image frame, for example.

The weight W is, for example, an evaluation index having taken into account the time length of the editing by the user, the degree of coincidence between the edited data and a heat map, or the like, and an image frame becomes more likely to be selected with the increase in the weight W, for example.

The data preferential selection unit 101 selects image frames in the segments obtained in the first comparative example by using the selection probability. The weight of data i edited by the user can be calculated by expression (1) shown below, for example, by using the time tₑ taken for the editing, the maximum value max(tₑ) of the time tₑ, the difference between an attention region Aᵢ generated by the attention region generation unit 103 and the edited attention region Eᵢ, the size sᵢ of the edited attention region relative to an image area S, and an attribute r of the user who performed the editing. In this case, the probability of being selected increases as a gap regarding the edited attention region increases and the region becomes narrower.

$$W = ( {t}_{e} / max ( {t}_{e} ) ) + ( ( {E}_{i} - {A}_{i} ) / {A}_{i} ) + S / {s}_{i} + r \qquad ( 1 )$$

As shown in the expression (1), the data preferential selection unit 101 is capable of setting the selection probability of an image frame having undergone the user editing in the image frames forming each video pair to be higher than the selection probability of an image frame having not undergone the user editing.

Further, when there occurred the user editing in image frames forming each video pair, the data preferential selection unit 101 can make the selection probability of such image frames higher with the increase in the length of a time range of the user editing.

Furthermore, when there occurred the user editing in image frames forming each video pair, the data preferential selection unit 101 can make the selection probability of such image frames higher with the increase in the length of the time taken for the user editing.

Moreover, when there occurred the user editing in image frames forming each video pair, the data preferential selection unit 101 can make the selection probability of such image frames higher with the increase in the difference between the attention region after the editing and the attention region before the editing.

In addition, when there occurred the user editing in image frames forming each video pair, the data preferential selection unit 101 can make the selection probability of such image frames higher with the decrease in the area of the attention region.

The model learning unit 102 performs feature extraction by inputting the video data selected by the data preferential selection unit 101 to a convolutional neural network (CNN).

The attention region generation unit 103 generates the attention region by using architecture having class activation mapping (CAM) structure branched therein, such as an attention branch network, and stores the result of the generation in the attention region storage unit 104.

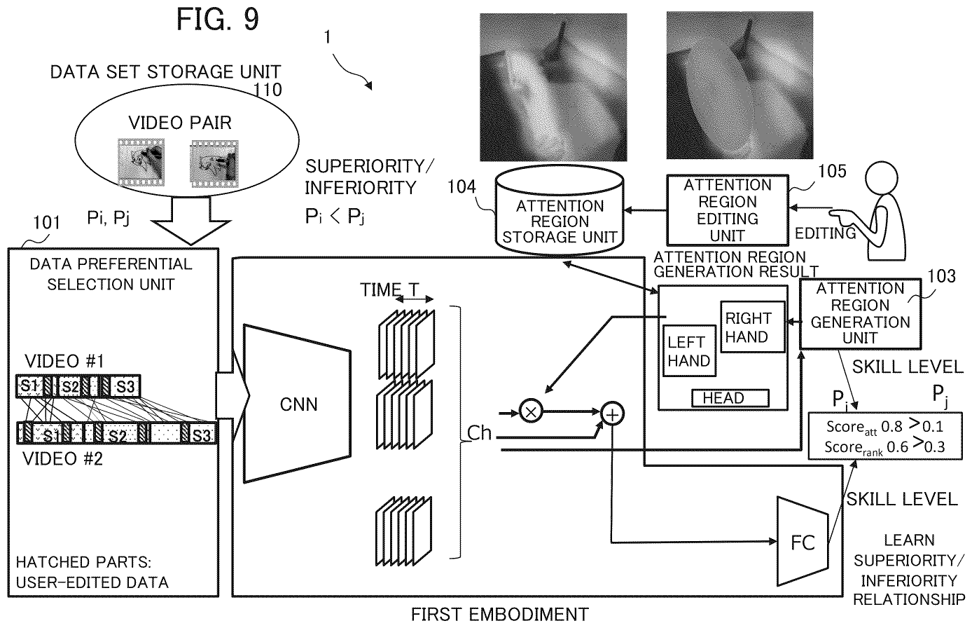

The model learning unit 102 extracts a feature regarding the attention region by masking a feature of the CNN in the attention region generated by the attention region generation unit 103. In FIG. 9, the data preferential selection unit 101 selects a video pair (i.e., a video Pᵢ as a video #1 and a video Pⱼ as a video #2) from the data set storage unit 110. Here, the skill level of the video Pⱼ is superior to the skill level of the video Pᵢ (this relationship is represented also as “Pᵢ<P;”). In this case, the score Score(Pⱼ) of the skill captured in the video Pⱼ should be determined to be higher than the score Score(Pᵢ) of the skill captured in the video Pᵢ.

FIG. 9 shows an example in which the score Scoreₐₜₜ(Pⱼ)=0.1 of the skill captured in the video Pⱼ regarding the attention region that the attention region generation unit 103 paid attention to is lower than the score Scoreₐₜₜ(Pᵢ)=0.8 of the skill captured in the video Pᵢ (i.e., an example in which the relationship between the scores regarding the attention region is inverted from the originally natural score relationship) and an example in which the score Scoreᵣₐₙₖ(Pⱼ)=0.3 of the skill captured in the video Pⱼ regarding the output from the FC layer is lower than the score Scoreᵣₐₙₖ(Pᵢ)=0.6 of the skill captured in the video Pᵢ (i.e., an example in which the relationship between the scores outputted from the FC layer is inverted from the originally natural score relationship).

The superiority/inferiority determination unit 106 extracts information on the superiority or inferiority determination by converting the result of extracting the feature regarding the attention region in the fully connected layer (FC layer). The information on the superiority or inferiority determination is an assessment result indicating which one of the skill level of the action captured in the video #1 and the skill level of the action captured in the video #2 is higher. The superiority/inferiority determination unit 106 obtains the difference from the attention region generated by the attention region generation unit 103 or the superiority or inferiority determination result of the determination by the superiority/inferiority determination unit 106, based on an attention region previously provided from the user or correct answer data regarding the superiority or inferiority determination. The superiority/inferiority determination unit 106 updates the CNN in the model learning unit 102 or the CAM in the attention region generation unit 103 and a parameter of its own FC layer by means of back propagation based on the calculated loss. The superiority/inferiority determination unit 106 checks whether a previously set learning convergence condition is satisfied or not, and ends the learning if the condition is satisfied, or repeats the learning from the selection of a plurality of pieces of data if the condition is not satisfied.

The attention region editing unit 105 acquires information on the attention region from the attention region storage unit 104 and visualizes the attention region for the user. The attention region editing unit 105 performs erasure or addition regarding the attention region by receiving the user's input operations. The attention region editing unit 105 stores a new attention region obtained by the editing by the user in the attention region storage unit 104 as learning data.

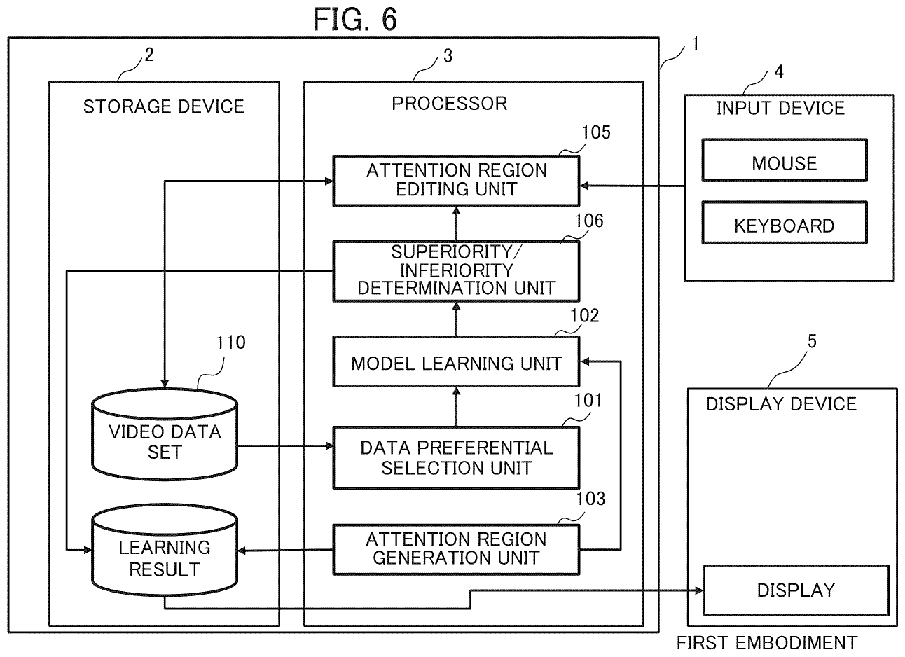

FIG. 6 is a diagram showing an example of the hardware configuration of the machine learning device 1 according to the first embodiment. The machine learning device 1 according to the first embodiment is a device that performs a learning process of generating a learning model by performing machine learning. Further, the machine learning device 1 in FIG. 6 has a function as a skill determination device that infers the skill level of the action of the action subject in an inputted video by using the learning model. The machine learning device 1 is a device capable of performing a machine learning method according to the first embodiment. While the machine learning device 1 is a computer, for example, the machine learning device 1 can also be a computer system formed by cloud computing by using a computer network. While FIG. 6 shows an example in which the machine learning device that generates the learning model and the skill determination device that determines the skill level of the action of the action subject in the video as the object are provided in the same computer, the machine learning device and the skill determination device may also be provided respectively in different computers.

The machine learning device 1 includes a processor 3 such as a CPU (Central Processing Unit) and a storage device 2. The storage device 2 is formed with a semiconductor memory such as a RAM (Random Access Memory), a hard disk drive (HDD), a solid state drive (SSD), or the like. The machine learning device 1 may include a communication device that performs communication with external devices. An input device 4 such as a mouse, a keyboard or the like and a display device 5 having a display are connected to the machine learning device 1. Further, the machine learning device 1 may include a communication device that performs communication with other devices.

Functions of the machine learning device 1 are implemented by processing circuitry. The processing circuitry is dedicated hardware, for example. The processing circuitry can be the processor 3 that performs a program (e.g., a machine learning program according to the embodiment) stored in the storage device 2. The processor 3 can also be a processing device, an arithmetic device, a microprocessor, a microcomputer or a DSP (Digital Signal Processor). The machine learning program is installed from a program stored in a record medium (i.e., storage medium) or by the downloading via the Internet. The record medium is a non-transitory computer-readable storage medium storing a program such as the machine learning program.

In the case where the processing circuitry is dedicated hardware, the processing circuitry is an ASIC (Application Specific Integrated Circuit), an FPGA (Field Programmable Gate Array) or the like, for example.

In the case where the processing circuitry is the processor 3, the machine learning method is performed by software, firmware, or a combination of software and firmware. The software and the firmware are described as programs and stored in the storage device 2. The processor 3 is capable of performing the machine learning method according to the first embodiment by reading out and performing the program stored in the storage device 2.

It is also possible to implement part of the machine learning device 1 by dedicated hardware and other part of the machine learning device 1 by software or firmware. As above, the processing circuitry is capable of implementing the above-described functions by hardware, software, firmware, or a combination of some of these means.

The user registers the data set for the learning (video data set) via the processor 3 by using the mouse or the keyboard. The processor 3 reads out the machine learning program stored in the storage device 2 and performs the learning or the inference. Based on the data set for the learning inputted by the user, the processor 3 performs the machine learning and the inference and stores the result in the storage device as a learning result.

The processor 3 extracts a plurality of pieces of data from the video data set. In the processor 3, the data preferential selection unit 101 extracts parts as comparison targets out of the plurality of pieces of data. In the processor 3, the model learning unit 102, the superiority/inferiority determination unit 106 and the attention region generation unit 103 assess the superiority or inferiority by making the comparison of the selected data, perform the learning so that an assessment value previously provided by a data set can be obtained, and register the result of generation of the attention region and the generated model in the learning result. The display device 5 displays the attention region generation result, and in response to the display, the user makes an annotation of the data through the input device 4. In the processor 3, the attention region editing unit 105 registers the result of the annotation in the data set as information for new machine learning.

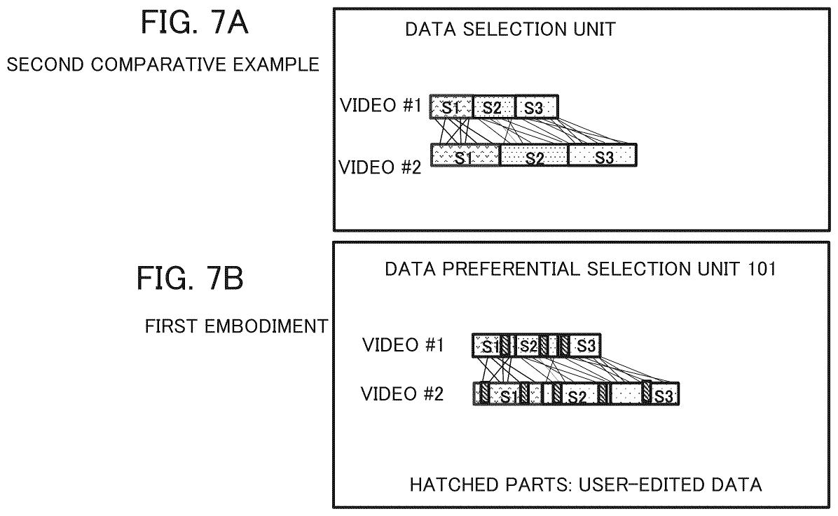

FIG. 7A is a diagram showing the segments S1, S2 and S3 of the videos selected from the video pair by the data selection unit in the second comparative example shown in FIG. 3 and FIG. 4. FIG. 7B is a diagram showing parts (hatched parts) selected from the segments of the video pair by the data preferential selection unit 101 in the first embodiment.

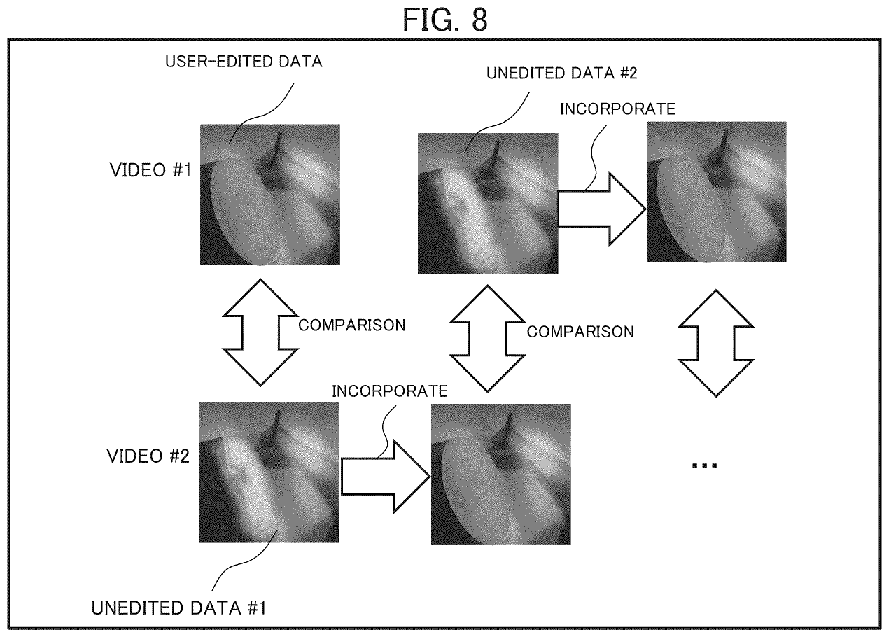

FIG. 8 is an explanatory diagram showing effects achieved by the machine learning device 1 according to the first embodiment. As shown in FIG. 8, the data preferential selection unit 101 appropriately selects image frames as data to be paired and is thereby capable of securing consistency of superiority or inferiority comparison points and the attention region comparison in cases of handling detailed motion as in a video displaying a skill. Accordingly, effects of increasing the skill determination accuracy and obtaining an appropriate explanation regarding the skill level can be expected. Further, the learning is stabilized since the skill level assessment becomes likely to be made between image frames intended by the user due to the comparison between image frames edited by the user. Furthermore, since the learning in consideration of the attention region is performed even regarding unedited regions due to the comparison between an image frame edited by the user and an unedited image frame, a similar attention region is generated even for unedited regions even though the regions have not been edited by the user.

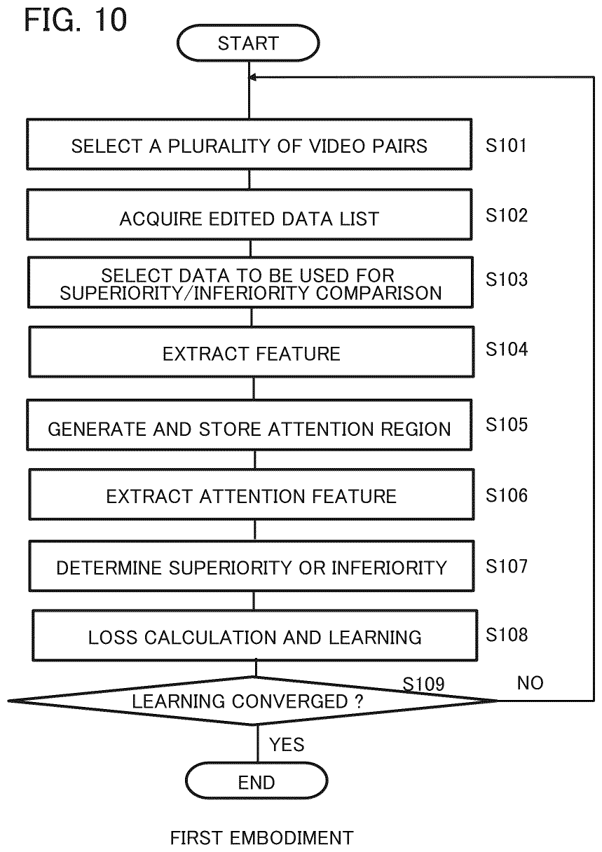

FIG. 9 is an explanatory diagram showing the operation of the machine learning device 1 according to the first embodiment. FIG. 10 is a flowchart showing a learning operation performed by the machine learning device 1 according to the first embodiment. First, the data preferential selection unit 101 selects a plurality of video pairs (i.e., Pᵢ as a video #1 and Pⱼ as a video #2) (step S101). Subsequently, the data preferential selection unit 101 acquires an edited data list, indicating what image frames in the videos forming the video pair have been edited by the user, from the attention region storage unit 104 (step S102).

Subsequently, the data preferential selection unit 101 weights the image frames by setting the weight of an edited image frame at W and setting the weight of an unedited image frame at 1 and calculates the selection probability indicating the probability that each image frame is selected. Further, the weight W may be varied based on an evaluation index having taken into account the time length of the editing by the user, the degree of coincidence between the edited data and the heat map, or the like. By using the obtained selection probability, the data preferential selection unit 101 selects image frames in the segments obtained by the segmentation like the conventional temporal segment network (step S103).

The model learning unit 102 performs the image feature extraction by inputting the data selected by the data preferential selection unit to the CNN (step S104).

The attention region generation unit 103 generates the attention region by using architecture having the CAM structure branched therein and stores the result of the generation in the attention region storage unit 104 (step S105).

The model learning unit 102 extracts the feature regarding the attention region (step S106).

The superiority/inferiority determination unit 106 extracts the information on the superiority or inferiority determination (step S107). The s information on the superiority or inferiority determination is the assessment result indicating which one of the skill level of the action captured in the video #1 and the skill level of the action captured in the video #2 is higher.

The superiority/inferiority determination unit 106 obtains the difference from the attention region generated by the attention region generation unit 103 or the superiority or inferiority determination result of the determination by the superiority/inferiority determination unit 106 based on the attention region previously provided from the user or the correct answer data regarding the superiority or inferiority determination. The superiority/inferiority determination unit 106 updates the CNN in the model learning unit 102 or the CAM in the attention region generation unit 103 and the parameter of its own FC layer by means of back propagation based on the calculated loss (step S108).

The superiority/inferiority determination unit 106 checks whether the previously set learning convergence condition is satisfied or not, and ends the learning if the condition is satisfied, or repeats the learning from the selection of a plurality of pieces of data if the condition is not satisfied (step S109).

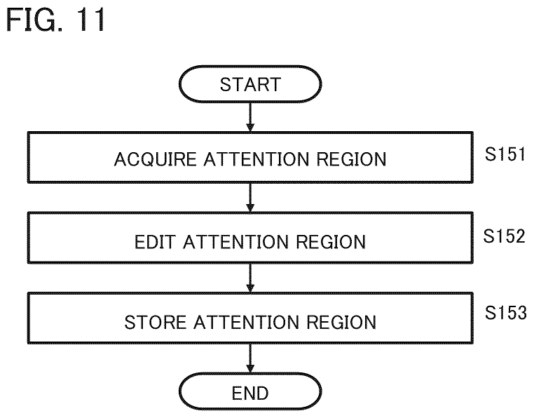

FIG. 11 is a flowchart showing the annotation made by the machine learning device 1 according to the first embodiment. The attention region editing unit 105 acquires the information on the attention region from the attention region storage unit 104 and visualizes the attention region for the user (presents the display screen 111) (step S151). Subsequently, the attention region editing unit 105 performs the editing of the attention region by receiving the user's input operations (step S152). The attention region editing unit 105 stores the new attention region obtained by the editing by the user in the attention region storage unit 104 as learning data (step S153).

As described above, according to the first embodiment, the learning behavior in the learning of the learning model for inferring the skill level of the action of the action subject in a video can be stabilized.

### (4) Second Embodiment

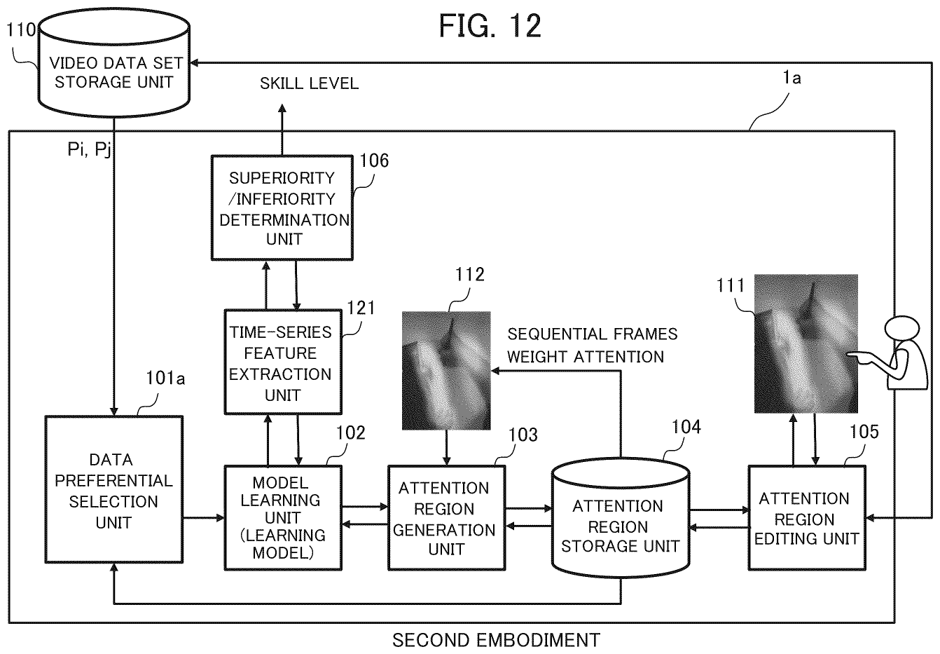

FIG. 12 is a functional block diagram schematically showing the configuration of a machine learning device 1a according to a second embodiment. In FIG. 12, each element identical or corresponding to an element shown in FIG. 5 is assigned the same reference character as in FIG. 5. The machine learning device 1a according to the second embodiment differs from the machine learning device 1 according to the first embodiment in including a data preferential selection unit (referred to also as a “pair data sequential selection unit”) 101a that selects sequential image frames and a time-series feature extraction unit 121 that extracts a feature of the sequential image frames.

The data preferential selection unit 101a in the machine learning device 1a according to the second embodiment determines the selection probability of each image frame based on a feature in a time direction in a plurality of sequential image frames forming each video pair.

In the machine learning device 1a according to the second embodiment, a plurality of sequential image frames are selected in order to increase the probability of selecting an appropriate video pair in the selection of a video pair (hit rate). In the first comparative example, the video data forming a video pair are segmented into segments and the image frames as the comparison targets are selected randomly, whereas the data preferential selection unit 101a in the machine learning device 1a according to the second embodiment selects a plurality of sequential image frames. Further, the machine learning device 1a further includes the time-series feature extraction unit 121 to be able to handle the feature of sequential image frames. Since the machine learning device 1a selects a plurality of sequential image frames, the probability that an image frame after undergoing the attention region editing is included in some image frames increases compared to the case where image frames after undergoing the attention region editing are selected randomly.

As the method of selecting a plurality of sequential image frames, there is the following method. In a first method, sequential data corresponding to a predetermined number of image frames is selected by designating random parts, by which the hit rate of data edited by the user increases compared to the method of randomly selecting image frames one by one. Examples of simulation of the hit rate will be shown below as Table 1.

TABLE 1

Annotation ratio for
1000-frame video data

| | 0.2 | 0.1 | 0.01 |
|---|---|---|---|
| Hit rate in 1000 samples | 47% | 27% | 4% |
| (conventional) | | | |
| The number of segments = 3 | | | |
| Hit rate in 1000 samples | 64% | 41% | 6% |
| (second embodiment) | | | |
| The number of sequential frames = 3 | | | |

In the machine learning device 1a according to the second embodiment, since the possibility that skill is included in the vicinity of data having undergone the user editing is high, the selection is made centering around the data having undergone the user editing at the time of day based on a probability distribution. By making the selection by previously preparing a plurality of variances of the normal distribution, the feature of a long time series and the feature of a short time series are selected.

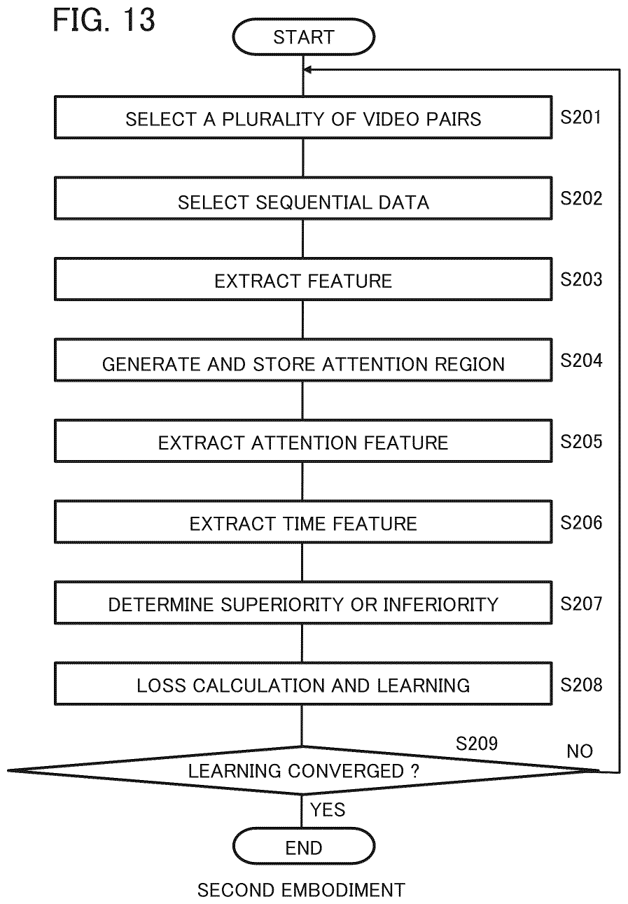

FIG. 13 is a flowchart showing a learning operation performed by the machine learning device 1a according to the second embodiment. The processing in steps S201, S203 to S205 and S207 to S209 in FIG. 13 is the same as the processing in the steps S101, S104 to S106 and S107 to S109 in FIG. 10.

In the second embodiment, the data preferential selection unit 101a functioning as the pair data sequential selection unit selects data of a plurality of sequential image frames (step S202). By selecting data sequential in the time direction as above, edited data of the attention region annotated by the user becomes likely to be included in targets of the superiority or inferiority determination.

Further, in the second embodiment, the time-series feature extraction unit 121 extracts the feature in the time direction from the video by performing the convolution in the time direction on the data of the plurality of sequential image frames (step S206).

As described above, according to the second embodiment, sequential detailed motion like that in a skill video can be grasped. At the same time, the hit rate of the attention region increases compared to the case of randomly selecting each time. Accordingly, the learning behavior in the learning of the learning model can be stabilized.

Except for the above-described features, the second embodiment is the same as the first embodiment. Further, the data preferential selection unit 101a and the time-series feature extraction unit 121 in the second embodiment are applicable also to the first embodiment.

### (5) Third Embodiment

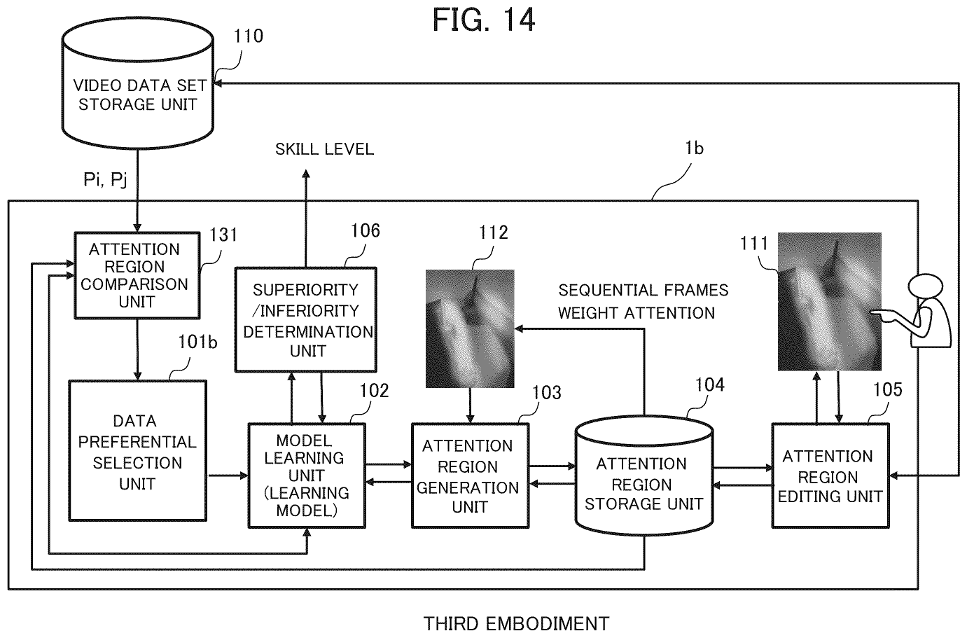

FIG. 14 is a functional block diagram schematically showing the configuration of a machine learning device 1b according to a third embodiment. In FIG. 14, each element identical or corresponding to an element shown in FIG. 5 is assigned the same reference character as in FIG. 5. The machine learning device 1b according to the third embodiment differs from the machine learning device 1 according to the first embodiment in including an attention region comparison unit 131 that calculates a similarity level between image frames edited by the user and in that a data preferential selection unit 101b selects data based on the similarity level.

In the second embodiment, even though the device includes the means for increasing the hit rate of image frames edited by the user, the contents of the editing performed are not taken into consideration, and thus there are cases where a video pair as a pair of videos different from each other in the contents is selected. Therefore, the machine learning device 1b according to the third embodiment is provided with the attention region comparison unit 131 and thereby makes comparison of the contents of the editing in addition to the comparison of the attention region. The data preferential selection unit 101b adjusts the selection probability so as to preferentially select a video pair as a pair of videos similar to each other in the contents of the editing. This makes it possible to compare attention regions similar to each other, and thus an increase in the accuracy of the skill level assessment can be expected.

In a first example of the third embodiment, first, the attention region comparison unit 131 calculates the similarity level between image frames having undergone the user editing. The data preferential selection unit 101b selects video data by giving higher priority (assigning a higher selection probability) to a video pair with the increase in the similarity level between image frames having undergone the user editing. However, when data having not undergone the user editing is included in a video pair, the selection probability is lowered by giving a low value (e.g., “0.01”) as the value of the similarity level. The model learning unit 102 performs the learning in regard to the selected video pair and the attention region generation unit 103 generates the attention region. When the selected pair is data having not undergone the user editing, the attention region comparison unit 131 calculates the similarity level with another image frame having undergone the user editing or data already selected as a pair.

In a second example of the third embodiment, first, the attention region comparison unit 131 calculates the similarity level between image frames having undergone the user editing. Subsequently, the attention region comparison unit 131 preferentially selects a pair dissimilar to each other at a certain probability. For example, a dissimilarity level is obtained by using a calculation formula “(dissimilarity level)=1.0−(similarity level)” and the selection probability is determined based on the dissimilarity level. This is because the selection of dissimilar video pair makes it more likely to generate an attention region not conceived by the user and including a video pair having not undergone the user editing at a certain probability, and that leads to discovery of a new attention region. The subsequent processing is the same as that in the first example of the third embodiment.

In a third example of the third embodiment, first, since it is difficult to hold the similarity levels of all the image frame pairs, the attention region comparison unit 131 forms clusters based on the similarity level and selects data based on the similarity level between clusters. In this case, the attention region comparison unit 131 regards each image frame having undergone the user editing as a cluster (in which the number of pieces of data is 1) and calculates the similarity level between clusters. Further, image frames having not undergone the user editing are all considered to belong to an unedited cluster. Subsequently, the attention region comparison unit 131 more preferentially selects a pair of clusters at a higher similarity level. The similarity level between the unedited cluster and another cluster is regarded as a predetermined low value. For example, the attention region comparison unit 131 randomly selects data, respectively included in the selected two clusters A and B, as a pair. Here, it is also possible for the attention region comparison unit 131 not to randomly select data but to select data at a representative point or data dissimilar to other data in the cluster. With such a selection method, learning by use of a representative point and a point far from the representative point as inputs progresses and the effect of discovering a new attention region can also be expected. Subsequently, in regard to the selected pair, the model learning unit 102 performs the learning and the attention region generation unit 103 generates the attention region. Subsequently, when the selected pair is data having not undergone the user editing, the attention region comparison unit 131 calculates the similarity levels with representative data in other clusters and makes the data belong to a cluster at the highest similarity level. Subsequently, the attention region comparison unit 131 updates the representative data as data at the highest similarity level in the cluster.

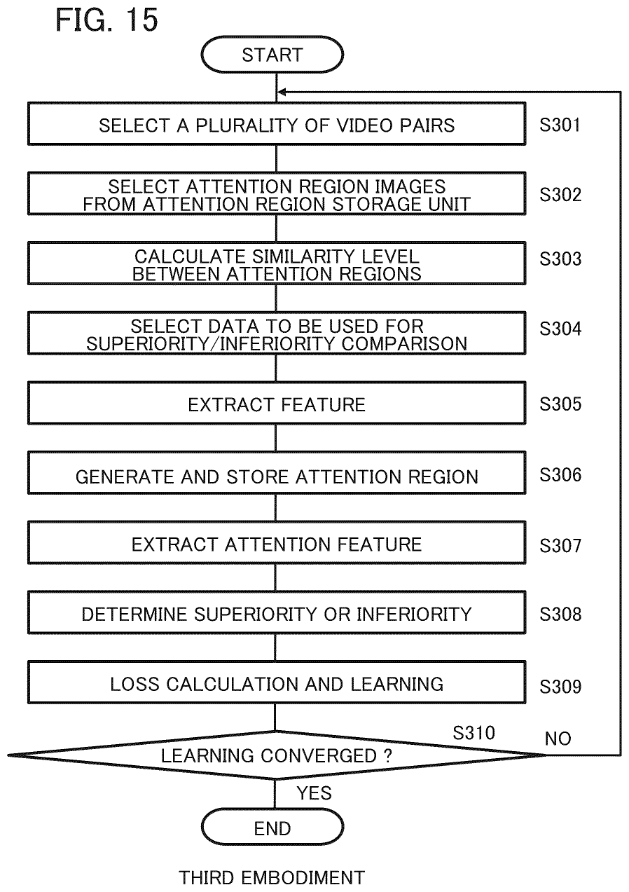

FIG. 15 is a flowchart showing a learning operation performed by the machine learning device 1b according to the third embodiment. The processing in steps S301 and S305 to S310 in FIG. 15 is the same as the processing in the steps S101 and S104 to S109 in FIG. 10.

The attention region comparison unit 131 selects data of a plurality of video pairs (step S301). The attention region comparison unit 131 selects attention region images (attention maps) from the data of the plurality of video pairs (step S302). The attention region comparison unit 131 calculates the similarity level between the attention region images (step S303). As the method of calculating the similarity level, it is possible to use IoU (Intersection over Union) calculating the degree of superimposition of the attention region images. The attention region comparison unit 131 obtains the total value of the similarity levels between the video #1 from a certain time tₖ to a certain time tₖ₊₁ and the video #2 from a certain time sₗ to a certain time sₗ₊₁. The attention region comparison unit 131 performs this processing for all sections and performs normalization so that the sum total equals 1. The data preferential selection unit 101b determines which ones of the section times tₖ−tₖ₊₁ and sₗ−sₗ₊₁ should be selected as sections of the pair data by using random numbers. It is also possible for the data preferential selection unit 101b to obtain the sections by, for example, assigning a weight to the similarity level so that images edited by the user become likely to be selected. Further, while the above-described calculation of the similarity level is performed for all combinations of the video #1 and the video #2, it is also possible to select one video randomly and select the other video based on the similarity level with the one video.

As described above, according to the third embodiment, sequential detailed motion like that in a skill video can be grasped. At the same time, the hit rate of the attention region increases compared to the case of randomly selecting each time. Accordingly, the learning behavior in the learning of the learning model can be stabilized.

Except for the above-described features, the third embodiment is the same as the first embodiment. Further, the data preferential selection unit 101b in the third embodiment is applicable also to the first or second embodiment.

### (6) Fourth Embodiment

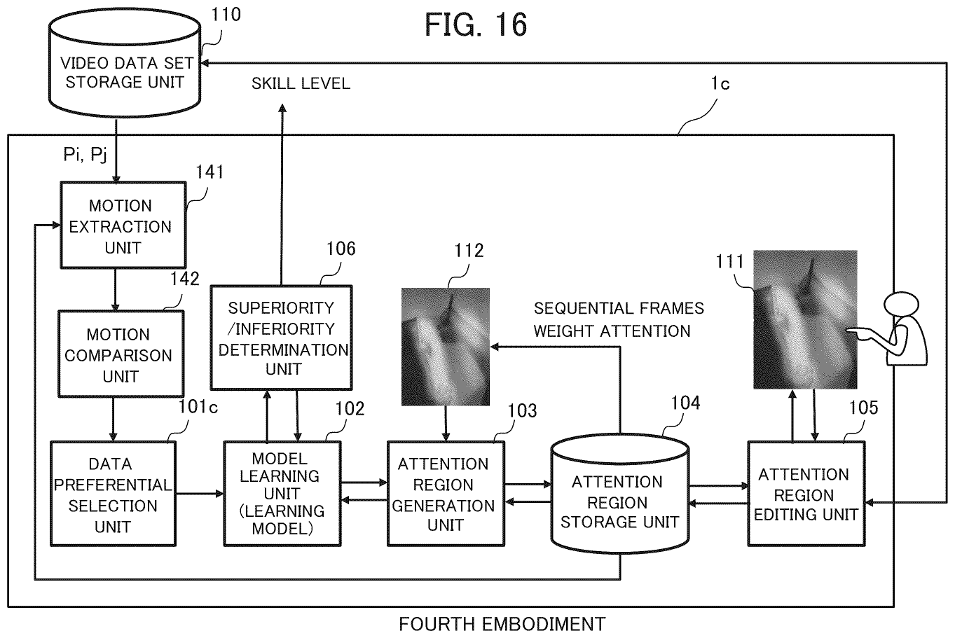

FIG. 16 is a functional block diagram schematically showing the configuration of a machine learning device 1c according to a fourth embodiment. In FIG. 16, each element identical or corresponding to an element shown in FIG. 5 is assigned the same reference character as in FIG. 5. The machine learning device 1c according to the fourth embodiment differs from the machine learning device 1 according to the first embodiment shown in FIG. 5 in including a motion extraction unit 141 and a motion comparison unit 142.

In the first to third embodiments, the motion of the action subject in the video is not sufficiently taken into consideration. In order to learn the learning model for determining the skill level, it is extremely important to determine whether a motion the same as a superior motion is made or not. The machine learning device 1c according to the fourth embodiment includes the motion extraction unit 141 and the motion comparison unit 142 and preferentially selects data and data close to each other in the motion as the video pair.

With the machine learning device 1c according to the fourth embodiment, data and data close to each other in the motion can be compared, and thus it becomes likely to select similar skill levels as assessment targets, and an increase in the accuracy of the skill level assessment can be expected.

As a first process example for determining the similarity level regarding the motion, a process using hand pose tracking can be considered. The first process example can be performed according to the following procedure including processes 11 to 15.
(Process 11) An image frame at a time t (t=0, Δt, 2Δt, 3Δt, . . . , NΔt) in each video is extracted. Here, N is a positive integer.
(Process 12) A motion vector (i.e., flow) is calculated from image frames from the time t=mΔt to the time t=(m+1)Δt, where m=0, 1, . . . , N−1.
(Process 13) A cosine distance of the motion vector (Δxₗ, Δyₗ) is calculated in regard to pairs made by all frames (Nₓ frames) of the video X and all frames (N_{y} frames) of the video Y. (Nₓ×N_{y}) cosine distances are calculated.
(Process 14) The process 13 is repeated for all video pairs.
(Process 15) A video pair is selected more preferentially with the increase in the similarity level obtained in the process 13.

As a second process example for determining the similarity level regarding the motion, a process that reduces the number of calculations by using clustering or the like can be considered. The second process example can be performed according to the following procedure including processes 21 to 26.
(Process 21) The same process as the process 11 in the first process example is performed.
(Process 22) The same process as the process 12 in the first process example is performed.
(Process 23) Only similarity levels between adjoining image frames in the video X are calculated and hierarchical clustering is performed. The number of clusters is determined by previous definition by the user or the like.
(Process 24) The similarity level between data and data included in a cluster in the process 23 is obtained, and data similar to all data in the cluster on average is designated as the representative data.
(Process 25) The similarity level is calculated in regard to the representative data between a cluster set (Cx) of the video X and a cluster set (Cy) of the video Y generated in the process 23 and the process 24.
(Process 26) Clusters are selected by using the similarity level between clusters calculated in the process 25, and a pair is obtained by randomly selecting data in the clusters. After the clusters are obtained, the same processing as that in the third embodiment can be employed.

While the user editing is not used in the fourth embodiment, it is also possible to select a pair of data by weighting the motion vector based on the user editing or by using an index obtained by combining the similarity level in the third embodiment obtained based on the user editing and the similarity level based on the motion vector or the like.

Further, it is also possible to obtain the similarity level in a particular range in the video by using a distance index of DTW (Dynamic Time Warping) or the like. In a method of averaging motion vectors of parts of the video X and obtaining an overall motion vector of one frame, a section from t=mₘᵢₙΔt to t=mₘₐₓΔt in the video X is selected and segmented into segments and the clustering is performed by obtaining the DTW distance between segments obtained by the segmentation. The selection probability is set so that items of data respectively belonging to the same clusters are likely to be selected as a pair. For example, items of in-cluster data of clusters are made to be likely to be selected as a pair. In this case, on rare occasions, a pair of items of data respectively in clusters different from each other is selected.

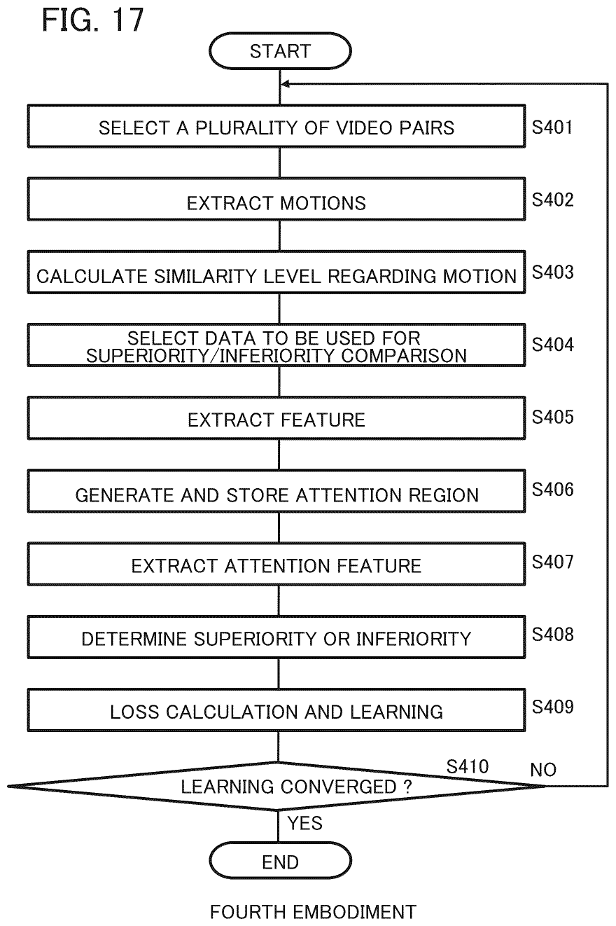

FIG. 17 is a flowchart showing a learning operation performed by the machine learning device 1c according to the fourth embodiment. The processing in steps S401 and S405 to S410 in FIG. 17 is the same as the processing in the steps S101 and S104 to S109 in FIG. 10.

The motion extraction unit 141 selects data of a plurality of video pairs (step S401). The motion comparison unit 142 extracts motions from the data of the plurality of video pairs by a technique such as optical flow (step S402). The motion extraction unit 141 may extract the direction of movement of a region obtained by dividing the image into blocks and hold the direction as a feature vector. The motion comparison unit 142 calculates the similarity level by using the cosine distance or the like of the feature vector of the extracted motion (step S403). The motion comparison unit 142 obtains the total value of the similarity levels between the video #1 from a certain time tₖ to a certain time tₖ₊₁ and the video #2 from a certain time sₗ to a certain time sₗ₊₁. The motion comparison unit 142 performs this processing for all sections and performs normalization so that the sum total equals 1. A data preferential selection unit 101c determines which ones of the section times tₖ−tₖ₊₁ and sₗ−sₗ₊₁ should be selected as sections of the pair data by using random numbers (step S404).

As described above, according to the fourth embodiment, motions are extracted from the data of a plurality of video pairs and the learning model is learned by using the extracted motions, and thus the learning behavior can be stabilized.

Except for the above-described features, the fourth embodiment is the same as the first embodiment. Further, the motion extraction unit 141 and the motion comparison unit 142 in the fourth embodiment are applicable to any one of the first to third embodiment.

### (7) Fifth Embodiment

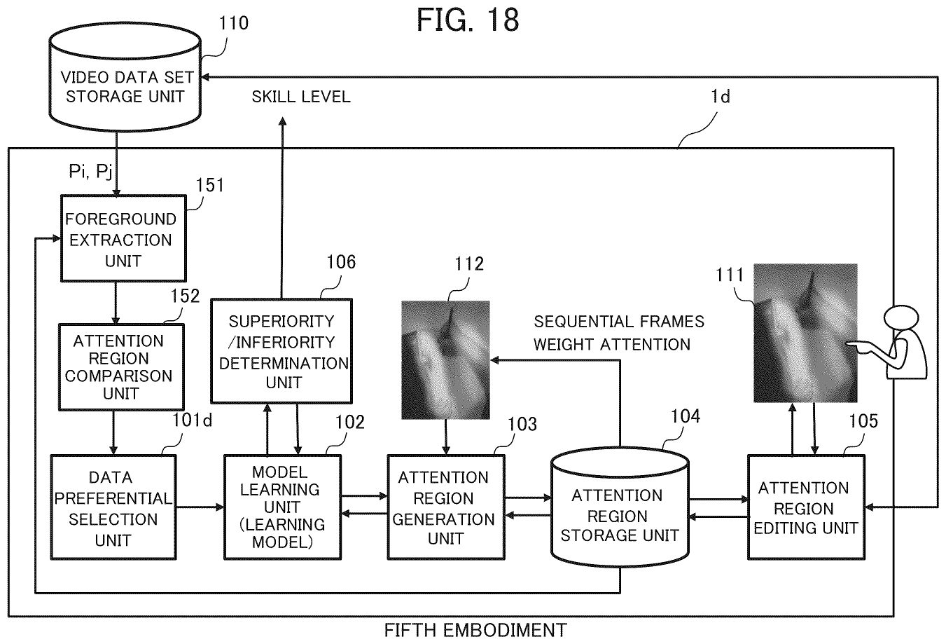

FIG. 18 is a functional block diagram schematically showing the configuration of a machine learning device 1d according to a fifth embodiment. In FIG. 18, each element identical or corresponding to an element shown in FIG. 5 is assigned the same reference character as in FIG. 5. The machine learning device 1d according to the fifth embodiment differs from the machine learning device 1 according to the first embodiment shown in FIG. 5 in including a foreground extraction unit 151 and an attention region comparison unit 152.

In the first to fourth embodiments, the description is given of examples in which the learning operation is performed in regard to the entirety of a video. However, when learning the learning model for inferring the skill level of the action of the action subject, there are cases where a result of analyzing the background of the video works as noise and deteriorates the determination accuracy of the skill level. Therefore, the machine learning device 1d according to the fifth embodiment includes the foreground extraction unit 151 that extracts foregrounds from the video pair selected from the video data set storage unit 110 and the attention region comparison unit 152 that calculates the similarity level regarding the attention region by using the foreground, obtained by masking the background being a region other than the foreground, as the attention region.

Since the region irrelevant to the skill level is masked as above, a video pair more likely to directly connect to the skill level is selected, and thus improvement in the accuracy of the skill level assessment and improvement in explainability regarding the assessment can be expected.

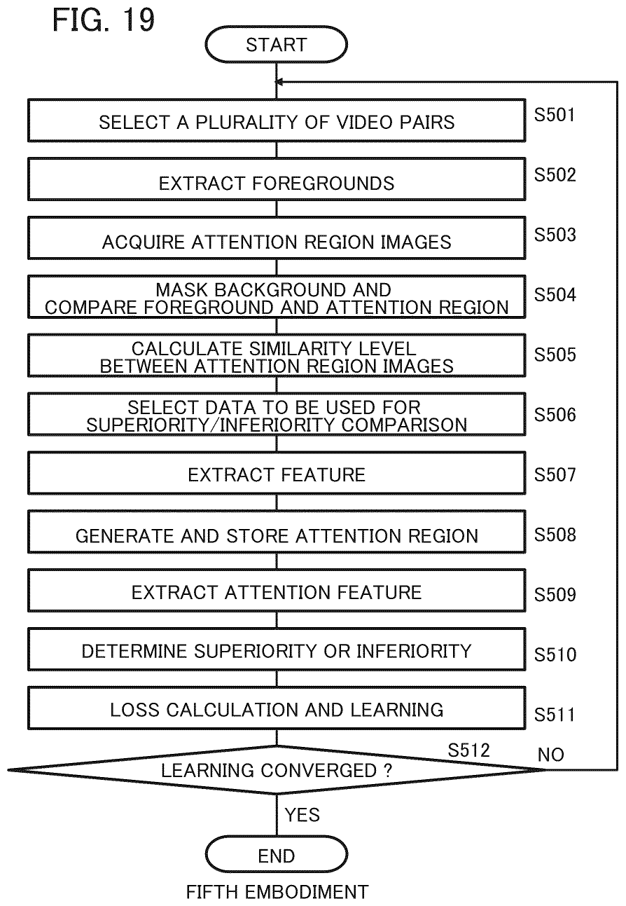

FIG. 19 is a flowchart showing a learning operation performed by the machine learning device 1d according to the fifth embodiment. The processing in steps S501 and S507 to S512 in FIG. 19 is the same as the processing in the steps S101 and S104 to S109 in FIG. 10.

First, the foreground extraction unit 151 selects a plurality of pieces of data from the video data set storage unit 110 and extracts the foregrounds (steps S501 and S502). The extraction of the foreground can be carried out by, for example, regarding a region where no change has occurred between the previous image frame and the present image frame as the background.

Subsequently, the foreground extraction unit 151 acquires the attention region images from the attention region storage unit 104 (step S503) and performs a mask process in regard to the foregrounds and the attention region images (step S504). The attention region comparison unit 152 calculates the similarity level between the masked attention region images (step S505). The attention region comparison unit 152 obtains the total value of the similarity levels between the video #1 from a certain time tₖ to a certain time tₖ₊₁ and the video #2 from a certain time sₗ to a certain time sₗ₊₁. The attention region comparison unit 152 performs this processing for all sections and performs normalization so that the sum total equals 1. A data preferential selection unit 101d determines which ones of the section times tₖ−tₖ₊₁ and sₗ−sₗ₊₁ should be selected as sections of the pair data by using random numbers.

As described above, according to the fifth embodiment, motions are extracted from the data of a plurality of video pairs and the learning model is learned by using the extracted motions, and thus the learning behavior can be stabilized.

Except for the above-described features, the fifth embodiment is the same as the first embodiment. Further, the foreground extraction unit 151 and the attention region comparison unit 152 in the fifth embodiment are applicable also to any one of the first to fourth embodiments.

### DESCRIPTION OF REFERENCE CHARACTERS

1, 1a-1d: machine learning device, 2: storage device, 3: processor, 4: input device, 5: display device, 101, 101a-101d: data preferential selection unit, 102: model learning unit, 103: attention region generation unit, 104: attention region storage unit, 105: attention region editing unit, 106: superiority/inferiority determination unit, 110: video data set storage unit, 111, 112: display example, 121: time-series feature extraction unit, 131: attention region comparison unit, 141: motion extraction unit, 142: motion comparison unit, 151: foreground extraction unit.

What is claimed is:

1. A machine learning device that learns a learning model for inferring a skill level of an action of an action subject in a video, the machine learning device comprising:
processing circuitry
to select a plurality of video pairs from a video data set for learning and to select image frames to be used for determining superiority or inferiority of the skill level from each video pair forming the plurality of selected video pairs;
to generate an attention region to be used for determining the superiority or inferiority of the skill level in the image frames;
to perform determination of the superiority or inferiority of the skill level in the attention region by using the learning model in regard to each video pair; and
to store the learning model and to update the learning model based on a result of the determination of the superiority or inferiority of the skill level,
wherein the processing circuitry selects the image frames to be used for determining the superiority or inferiority of the skill level by using selection probability determined based on one or more of user editing in the image frames forming each video pair, a feature in a time direction in a plurality of sequential image frames forming each video pair, and a similarity level between the image frames forming each video pair.

2. The machine learning device according to claim 1, wherein the processing circuitry sets the selection probability of an image frame having undergone the user editing in the image frames forming each video pair to be higher than the selection probability of an image frame having not undergone the user editing.

3. The machine learning device according to claim 1, wherein when there occurred the user editing in image frames forming each video pair, the processing circuitry makes the selection probability of the image frames higher with an increase in a length of a time range of the user editing.

4. The machine learning device according to claim 1, wherein when there occurred the user editing in image frames forming each video pair, the processing circuitry makes the selection probability of the image frames higher with an increase in a length of a time taken for the user editing.

5. The machine learning device according to claim 1, wherein when there occurred the user editing in image frames forming each video pair, the processing circuitry makes the selection probability of the image frames higher with an increase in a difference between the attention region after the editing and the attention region before the editing.

6. The machine learning device according to claim 1, wherein when there occurred the user editing in image frames forming each video pair, the processing circuitry makes the selection probability of the image frames higher with a decrease in area of the attention region.

7. The machine learning device according to claim 1, wherein the processing circuitry determines the selection probability of each image frame based on a feature in the time direction in a plurality of sequential image frames forming each video pair.

8. The machine learning device according to claim 1, wherein the processing circuitry
calculates the similarity level of each video pair regarding the attention region, and
increases the selection probability with an increase in the similarity level between the attention regions of the image frames forming each video pair.

9. The machine learning device according to claim 1, wherein the processing circuitry
extracts motions in the attention regions in the video pair,
calculates the similarity level between the motions in the attention regions in the video pair, and
increases the selection probability with an increase in the similarity level between the motions.

10. The machine learning device according to claim 1, wherein the processing circuitry
extracts foregrounds of each video pair,
calculates the similarity level between the attention regions in the foregrounds, and
increases the selection probability with an increase in the similarity level between the attention regions in the foregrounds.

11. The machine learning device according to claim 1, wherein the action subject is a person or a mechanism that moves in conjunction with movement of a person's body part.

12. A skill determination device comprising:
the learning model generated by the machine learning device according to claim 1,
wherein the skill determination device determines a skill level of an action of an action subject in a video as an object by using the learning model.

13. A machine learning method of learning a learning model for inferring a skill level of an action of an action subject in a video, the machine learning method comprising:
selecting a plurality of video pairs from a video data set for learning and selecting image frames to be used for determining superiority or inferiority of the skill level from each video pair forming the plurality of selected video pairs;
generating an attention region to be used for determining the superiority or inferiority of the skill level in the image frames;
performing determination of the superiority or inferiority of the skill level in the attention region by using the learning model in regard to each video pair; and
storing the learning model and updating the learning model based on a result of the determination of the superiority or inferiority of the skill level,
wherein in said selecting image frames to be used for determining the superiority or inferiority of the skill level, the image frames to be used for determining the superiority or inferiority of the skill level are selected by using selection probability determined based on one or more of user editing in the image frames forming each video pair, a feature in a time direction in a plurality of sequential image frames forming each video pair, and a similarity level between the image frames forming each video pair.

14. A non-transitory computer-readable storage medium storing a machine learning program that causes a computer to learn a learning model for inferring a skill level of an action of an action subject in a video, the machine learning program comprising:
selecting a plurality of video pairs from a video data set for learning and selecting image frames to be used for determining superiority or inferiority of the skill level from each video pair forming the plurality of selected video pairs;
generating an attention region to be used for determining the superiority or inferiority of the skill level in the image frames;
performing determination of the superiority or inferiority of the skill level in the attention region by using the learning model in regard to each video pair; and
storing the learning model and updating the learning model based on a result of the determination of the superiority or inferiority of the skill level,
wherein in said step of selecting image frames to be used for determining the superiority or inferiority of the skill level, the image frames to be used for determining the superiority or inferiority of the skill level are selected by using selection probability determined based on one or more of user editing in the image frames forming each video pair, a feature in a time direction in a plurality of sequential image frames forming each video pair, and a similarity level between the image frames forming each video pair.
